(19) United States
(12) Patent Application Publication
(10) Pub. No.: US 2025/0217192 A1
(43) Pub. Date: Jul. 3, 2025

(54) GRAPH AWARE MEMORY ALLOCATION

(71) Applicant: QUALCOMM Incorporated, San Diego, CA (US)

(72) Inventors: Siva Rama Krishna Reddy BOGI REDDY, Bengaluru (IN); Krishna Raju VEGIRAJU, Hyderabad (IN); Shwetank SINGH, Bangalore (IN); Hongqiang WANG, San Diego, CA (US)

(21) Appl. No.: 18/400,281

(22) Filed: Dec. 29, 2023

(51) Int. Cl. G06F 9/50

(52) U.S. Cl. CPC G06F 9/5016; G06F 9/5033

(57) ABSTRACT

A processor-implemented method includes determining a lifespan of each tensor generated by a deep neural network based on an architecture of the deep neural network. The method also includes allocating memory to each tensor based on lifespan data. The process also allocates the memory based on availability of edge segments in the memory. The memory may be on-chip memory.

### BACKGROUND

### Field

Aspects of the present disclosure relate to computing devices, and more specifically to a memory allocation technique that accounts for an architecture of a deep neural network.

### Background

Mobile or portable computing devices include mobile phones, laptop computers, palmtop computers, tablet computers, portable digital assistants (PDAs), portable game consoles, and other portable electronic devices. Mobile computing devices are comprised of many electrical components that may store data locally in on-chip memory and/or off-chip memory. The components (or compute devices) may include system-on-a-chip (SoC) devices, graphics processing unit (GPU) devices, neural processing unit (NPU) devices, digital signal processors (DSPs), and modems, among others. Currently, computing devices may not efficiently allocate on-chip memory, causing unnecessary use of off-chip memory. More efficient memory allocation techniques are desired.

### SUMMARY

In aspects of the present disclosure, a processor-implemented method includes determining a lifespan of each tensor generated by a deep neural network based on an architecture of the deep neural network. The method also includes allocating memory to each tensor based on lifespan data.

Other aspects of the present disclosure are directed to an apparatus. The apparatus one or more memories and one or more processors coupled to the one or more memories. The processor(s) is configured to determine a lifespan of each tensor generated by a deep neural network based on an architecture of the deep neural network. The processor(s) is also configured to allocate memory to each tensor based on lifespan data.

Other aspects of the present disclosure are directed to an apparatus. The apparatus includes means for determining a lifespan of each tensor generated by a deep neural network based on an architecture of the deep neural network. The apparatus also includes means for allocating memory to each tensor based on lifespan data.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including a graph aware memory allocator, in accordance with various aspects of the present disclosure.

FIG. 2 is a block diagram illustrating an exemplary deep convolutional network (DCN), in accordance with various aspects of the present disclosure.

FIGS. 3A and 3B are block diagrams illustrating memory allocation for a deep neural network.

FIG. 4 is a block diagram illustrating memory allocation for a deep neural network.

FIG. 5 is a block diagram illustrating a naïve approach of memory allocation and deallocation for a deep neural network.

FIG. 6 is a flow diagram illustrating memory allocation for a deep neural network, in accordance with various aspects of the present disclosure.

FIG. 7 is a block diagram illustrating memory allocation and deallocation for a deep neural network, in accordance with various aspects of the present disclosure.

FIG. 8 is a block diagram illustrating memory allocation for a deep neural network based on lifespan data, in accordance with various aspects of the present disclosure.

FIG. 9 is a flow diagram illustrating an example process performed, for example, by a computing device, in accordance with various aspects of the present disclosure.

FIG. 10 is a block diagram showing an exemplary wireless communications system in which a configuration of the present disclosure may be advantageously employed.

FIG. 11 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Deep neural networks (DNN) may execute on a computing device having an accelerator. Such execution specifies a large amount of memory to be allocated for storing the parameters and the activations of the neural network. The parameters and activations may be represented as tensors, which are then stored in memory based on memory allocations. In some implementations, multilevel memory is available, including a limited amount of on-chip memory and a larger amount of external memory.

Aspects of the present disclosure use graph information (or network architecture information) of the DNN to enhance utilization of on-chip memory. More specifically, a memory allocation mechanism is aware of a DNN graph. Awareness refers to the lifespan of each tensor in a feed forward graph execution. In other words, the last layer of the network that utilizes each tensor is noted. The allocation mechanism uses the tensor lifespan to efficiently determine an appropriate location within the on-chip memory for storing each tensor.

While planning memory allocation for DNNs, the graph aware memory allocator initially obtains information about each tensor that will receive a memory allocation, as well as when each tensor may be removed from memory (also referred to as an expiration time or a lifespan). Every memory segment may be tagged with an expiration time (or memory removal time/lifespan) that indicates a layer after which the tensor becomes invalid. When multiple options are available for allocating a tensor to memory, the graph aware memory allocator allocates the tensor adjacent to a memory segment that expires at a time close to this new allocation. When there are multiple options with a same distance between expiration times, the graph aware memory allocator selects a smallest segment. If an edge segment is available, the graph aware memory allocator selects the edge segment.

Particular aspects of the subject matter described in this disclosure can be implemented to realize one or more of the following potential advantages. In some examples, the described techniques, such as graph aware memory allocation, enables efficient use of the on-chip memory, improving on-chip memory utilization, resulting in better performance of the applications accessing the memory.

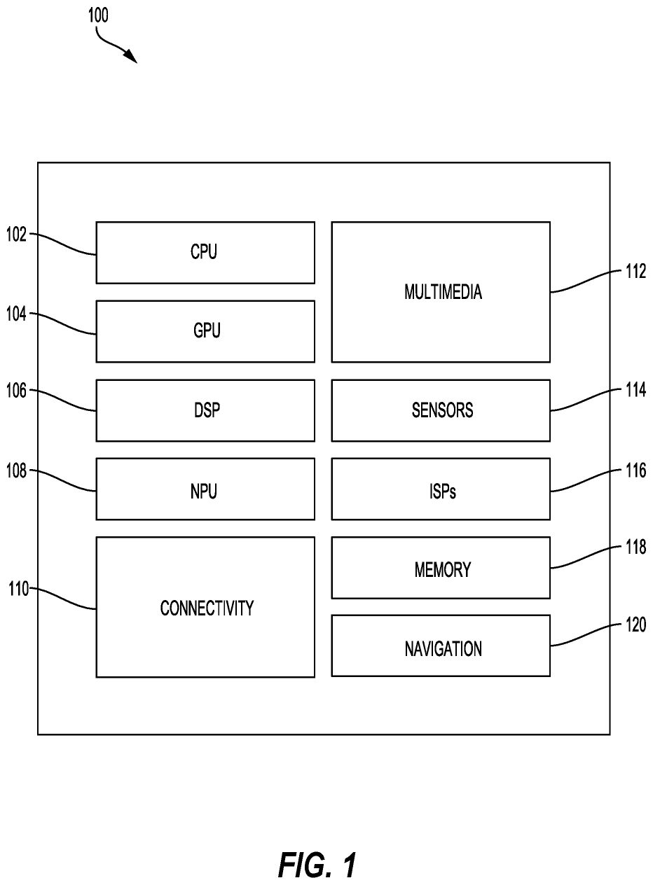

FIG. 1 illustrates an example implementation of a host system-on-a-chip (SoC) 100, which includes a graph aware memory allocator, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

Deep learning architectures may perform tasks, such as an object recognition task, by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections, as well as skip connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. A skip connection is a connection from a neuron in a first layer to a neuron in a later layer, where the later layer does not immediately follow the first layer. For example, in a deep neural network (DNN) with five layers consecutively numbered, a skip connection would be a connection from the first layer to the third, fourth, or fifth layer.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

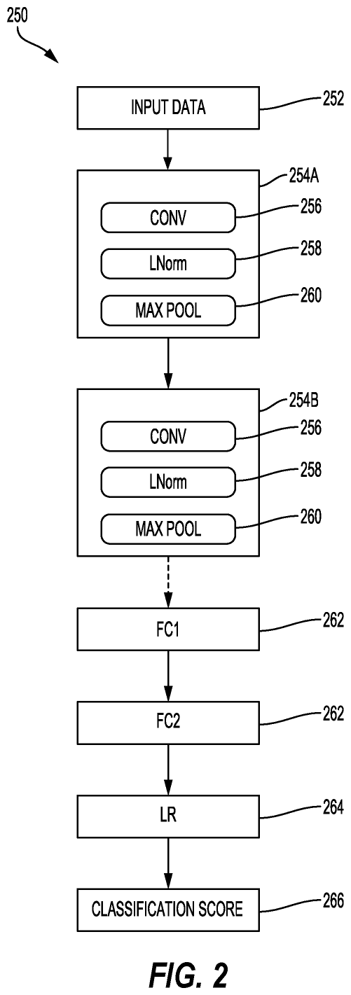

FIG. 2 is a block diagram illustrating a DCN 250. The DCN 250 may include multiple different types of layers based on connectivity and weight sharing. As shown in FIG. 2, the DCN 250 includes the convolution blocks 254A, 254B. Each of the convolution blocks 254A, 254B may be configured with a convolution layer (CONV) 256, a normalization layer (LNorm) 258, and a max pooling layer (MAX POOL) 260.

Although only two of the convolution blocks 254A, 254B are shown, the present disclosure is not so limiting, and instead, any number of the convolution blocks 254A, 254B may be included in the DCN 250 according to design preference.

The convolution layers 256 may include one or more convolutional filters, which may be applied to the input data to generate a feature map. The normalization layer 258 may normalize the output of the convolution filters. For example, the normalization layer 258 may provide whitening or lateral inhibition. The max pooling layer 260 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 250 may access other processing blocks that may be present on the SOC 100, such as sensor processor 114 and navigation module 120, dedicated, respectively, to sensors and navigation.

The DCN 250 may also include one or more fully connected layers 262 (FC1 and FC2). The DCN 250 may further include a logistic regression (LR) layer 264. Between each layer 256, 258, 260, 262, 264 of the DCN 250 are weights (not shown) that are to be updated. The output of each of the layers (e.g., 256, 258, 260, 262, 264) may serve as an input of a succeeding one of the layers (e.g., 256, 258, 260, 262, 264) in the DCN 250 to learn hierarchical feature representations from input data 252 (e.g., images, audio, video, sensor data and/or other input data) supplied at the first of the convolution blocks 254A. The output of the DCN 250 is a classification score 266 for the input data 252. The classification score 266 may be a set of probabilities, where each probability is the probability of the input data including a feature from a set of features.

As noted above, it would be desirable to improve on-chip memory allocation. Efficient use of the on-chip memory improves the on-chip memory utilization, resulting in better performance of the applications accessing the memory.

Aspects of the present disclosure are directed to a graph aware memory allocator that allocates on-chip memory based on an architecture of a deep neural network. According to aspects of the present disclosure, a computing device includes a CPU 102, GPU 104, DSP 106, NPU 108, and/or memory 118, as shown in FIG. 1 The computing device may include means for determining, means for allocating, and means for selecting, which may be the CPU 102, GPU 104, DSP 106, NPU 108, and/or memory 118, as shown in FIG. 1. In other aspects, the aforementioned means may be any structure or any material configured to perform the functions recited by the aforementioned means.

Deep neural networks (DNNs) may execute on a computing device having an accelerator. Such execution specifies a large amount of memory to be allocated for storing the parameters and the activations of the neural network. The parameters and activation may be represented as tensors, which are then stored in memory based on memory allocations. In general, an operating system application programming interface (API) allocates memory as needed. Accelerators without any memory manager require the applications to handle the memory allocation. In some implementations, multilevel memory is available, including a limited amount of on-chip memory and a larger amount of external memory. The on-chip memory may be referred to as L3 memory and may operate without a memory manager. The external memory, for example double data rate (DDR) memory, may operate with a memory manager.

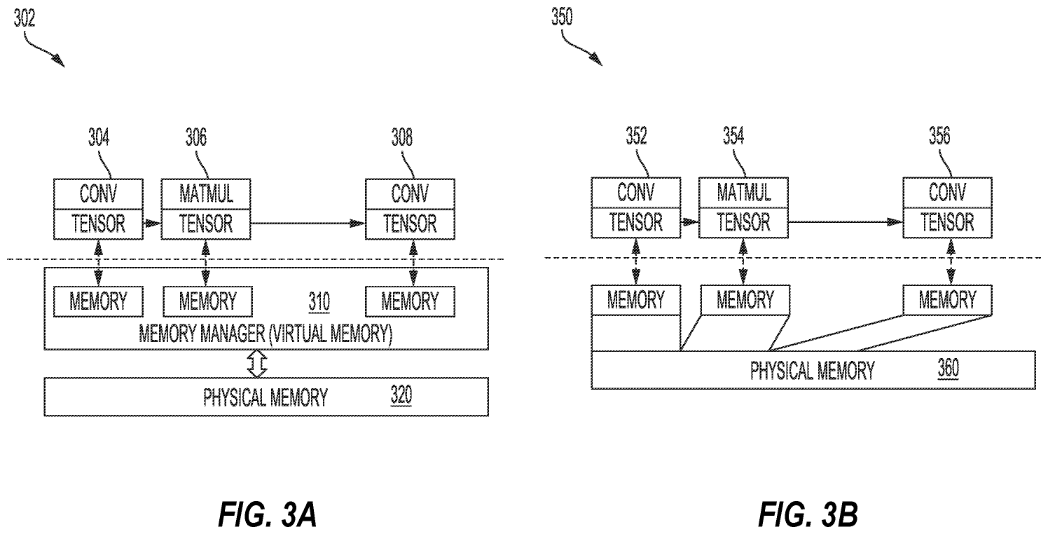

FIGS. 3A and 3B are block diagrams illustrating memory allocation for a deep neural network (DNN). In the example of FIG. 3A, a deep neural network 302 is shown with three layers: a first convolution layer (CONV) 304, a matrix multiplication layer (MATMUL) 306, and a second convolution layer 308. The first convolution layer 304 generates a first tensor that is stored in virtual memory 310 and input to the matrix multiplication layer 306. The matrix multiplication layer 306 generates a second tensor based on the first tensor, the second tensor being stored in the virtual memory 310 and input to the second convolution layer 308. The second convolution layer 308 generates a third tensor that is stored in the virtual memory 310 based on the second tensor. A memory manager maps the virtual memory 310 to physical memory 320.

In the example of FIG. 3B, a deep neural network 350 is shown with three layers: a first convolution layer (CONV) 352, a matrix multiplication layer (MATMUL) 354, and a second convolution layer 356. The first convolution layer 352 generates a first tensor that is stored in physical memory 360 and input to the matrix multiplication layer 354. The matrix multiplication layer 354 generates a second tensor based on the first tensor, the second tensor being stored in the physical memory 360 and input to the second convolution layer 356. The second convolution layer 356 generates a third tensor that is stored in the physical memory 360 and is based on the second tensor.

A GPU, such as the GPU 104, may include on-chip memory referred to as graphics memory, and may also be allocated external memory, e.g., DDR. In some exemplary implementations, the graphics memory is limited to 3 MB. The applications executing on the GPU are responsible for managing allocations for both types of memory. Traditional memory allocation strategies, such as a virtual machine (VM)-based memory manager or a simple naïve allocator, may not be efficient for GPU applications. For example, a DNN executing on a GPU with conventional memory allocation may not operate in a most efficient manner.

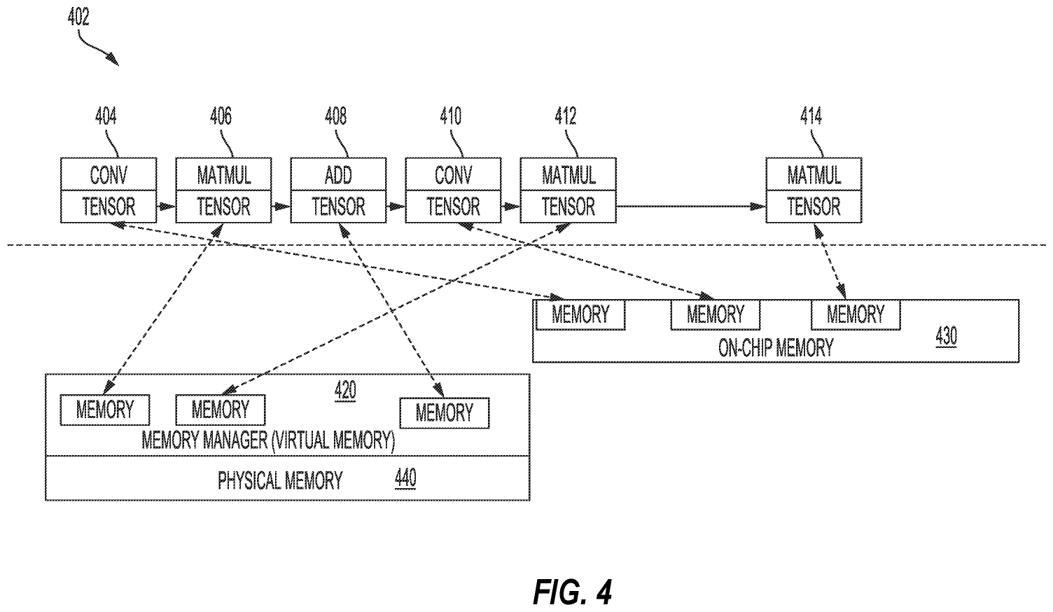

FIG. 4 is a block diagram illustrating memory allocation for a deep neural network (DNN). In the example of FIG. 4, the memory manager is unaware of the DNN architecture. The example of FIG. 4 illustrates a deep neural network 402 having six layers: a first convolution layer (CONV) 404, a first matrix multiplication layer (MATMUL) 406, an addition layer (ADD) 408, a second convolution layer 410, a second matrix multiplication layer 412, and a third matrix multiplication layer 414. The first convolution layer 404 generates a first tensor that is stored in on-chip memory 430 and input to the first matrix multiplication layer 406. The first matrix multiplication layer 406 generates a second tensor based on the first tensor, the second tensor being stored in virtual memory 420 (and ultimately physical memory 440 via a memory manager) and input to the addition layer 408. The addition layer 408 generates a third tensor that is stored in the virtual memory 420 based on the second tensor. The memory manager maps the virtual memory 420 to the physical memory 440. The second convolution layer 410 generates a fourth tensor that is stored in the on-chip memory 430 and input to the second matrix multiplication layer 412, based on the third tensor. The second matrix multiplication layer 412 generates a fifth tensor based on the fourth tensor, the fifth tensor being stored in the virtual memory 420 (and ultimately the physical memory 440 via the memory manager) and input to the third matrix multiplication layer 414. The third matrix multiplication layer 414 generates a sixth tensor that is stored in the on-chip memory 430.

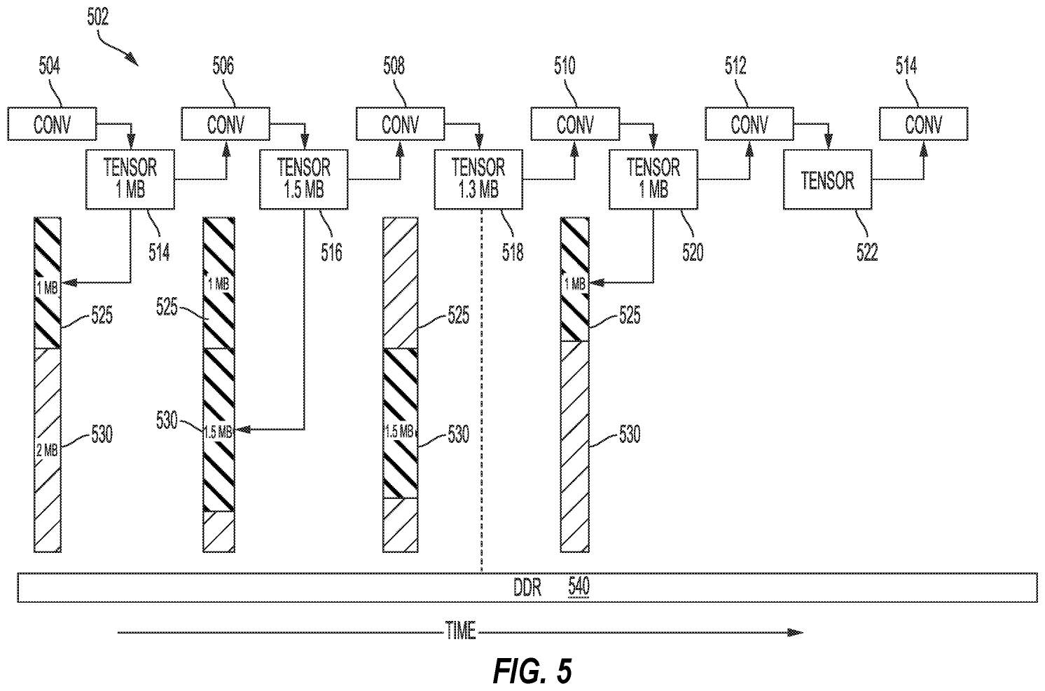

FIG. 5 is a block diagram illustrating a naïve approach of memory allocation and deallocation for a deep neural network (DNN). In the example of FIG. 5, the memory manager is unaware of the DNN architecture. The example of FIG. 5 illustrates a deep neural network 502 having six convolution layers (CONV) 504, 506, 508, 510, 512, and 524. The first convolution layer 504 generates a first tensor 514 that is stored in a first location 525 of on-chip memory and input to the second convolution layer 506. The first tensor has a size of 1 MB and fits in the first location 525 of the 3 MB on-chip memory, leaving 2 MB free in a second location 530 of the on-chip memory. The second convolution layer 506 generates a second tensor 516 based on the first tensor, the second tensor 516 being stored in the second location 530 of the on-chip memory and input to the third convolution layer 508. The second tensor 516 has a size of 1.5 MB and fits within the free 2 MB at the second location 530 of the on-chip memory.

The third convolution layer 508 generates a third tensor 518 based on the second tensor 516. The third tensor 518 has a size of 1.3 MB. Although 1.3 MB is available in the on-chip memory due to the first location 525 becoming free after the 1 MB first tensor 514 was input to the second convolution layer 506, there is no contiguous 1.3 MB available. Thus, the third tensor 518 is stored in the external memory (e.g., DDR) 540.

The fourth convolution layer 510 generates a 1 MB fourth tensor 520 that is stored in the first location 525 of the on-chip memory and input to the fifth convolution layer 512. At this moment, the second tensor 516 has been deallocated from the second location 530 due to the fact that the second tensor 516 was already input to the third convolution layer 508 and will not be used again. The memory allocation for the fifth tensor 522 is not shown but operates in a similar manner. The fifth tensor 522 is input to the sixth convolution layer 524.

As seen in FIG. 5, the naïve approach fails to efficiently allocate on-chip memory due to fragmentation. Thus, it is important to ensure free memory is available as a continuous block. Although the DNNs of FIGS. 3A, 3B, 4, and 5 show tensors consumed immediately at a next layer of the neural network, some tensors may remain in memory for a longer time, such as with skip connections where a tensor is not consumed until at least one intermediate layer has completed processing. These skip connection tensors should remain in memory for a longer time than the tensors consumed immediately at the next layer, which may be deallocated from memory immediately.

Aspects of the present disclosure use graph information (or network architecture information) of the DNN to enhance utilization of on-chip memory. More specifically, a memory allocation mechanism is aware of a DNN graph. Awareness refers to the lifespan of each tensor in a feed forward graph execution. In other words, the last layer of the network that utilizes each tensor is noted. The allocation mechanism uses the tensor lifespan to efficiently determine an appropriate location within the on-chip memory for storing each tensor.

While planning memory allocation for DNNs, the graph aware memory allocator initially obtains information about each tensor that will receive a memory allocation, as well as when each tensor may be removed from memory (also referred to as an expiration time or a lifespan). Every memory segment may be tagged with an expiration time (or memory removal time/lifespan) that indicates a layer after which the tensor becomes invalid. When multiple options are available for allocating a tensor to memory, the graph aware memory allocator allocates the tensor adjacent to a memory segment that expires at a time close to this new allocation. For example, if a new tensor expires at layer 20, and a first tensor currently stored in a memory segment expires at layer 20 and a second tensor currently stored in memory expires at layer 25, the new tensor may be allocated to a segment adjacent to the first tensor currently stored in memory. When there are multiple options with a same distance between expiration times, the graph aware memory allocator selects a smallest segment. If an edge segment is available, the graph aware memory allocator selects the edge segment. In other words, a memory segment having the offset 0 (beginning) or a max_offset (end) is considered as having the smallest distance while performing the distance calculation. ‘Distance’ may be defined as the difference between the layer numbers after which the allocation will expire. In some implementations, the distance with any boundary edge is −1.

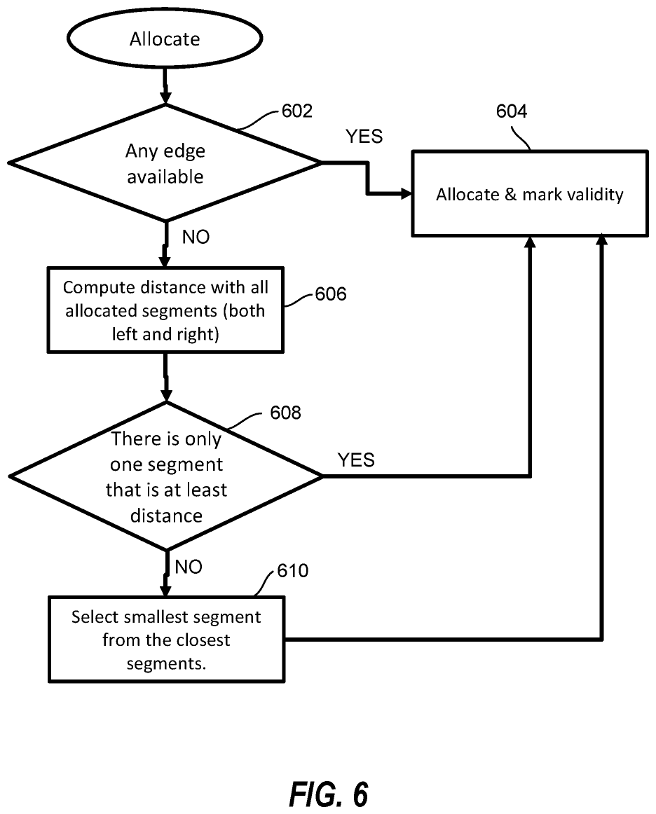

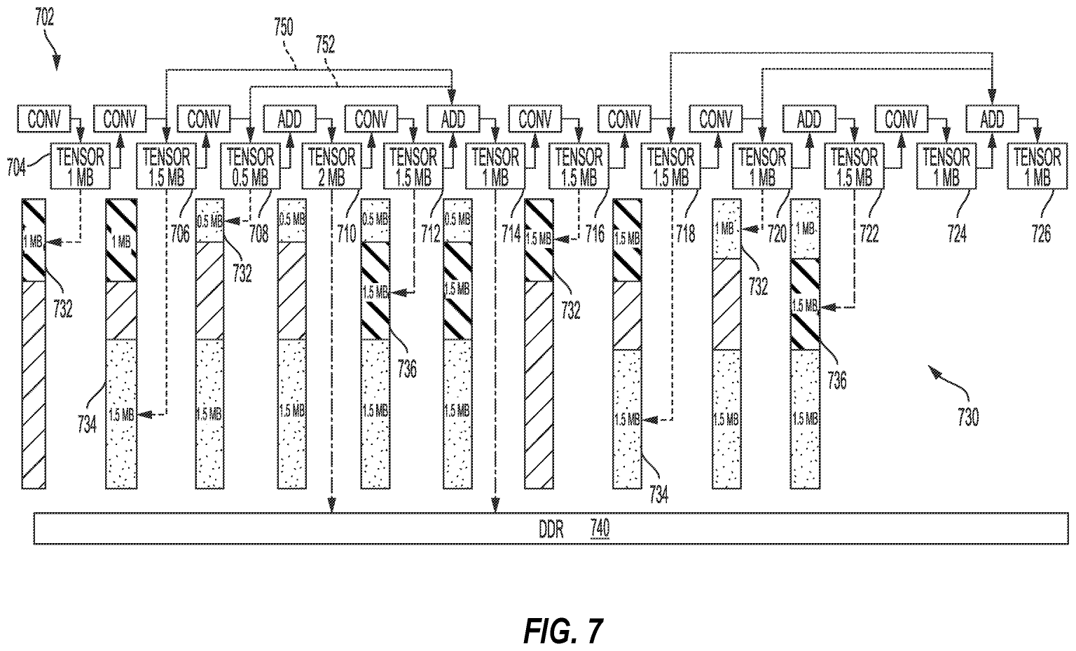

FIG. 6 is a flow diagram illustrating memory allocation for a deep neural network, in accordance with various aspects of the present disclosure. FIG. 7 is a block diagram illustrating memory allocation and deallocation for a deep neural network, in accordance with various aspects of the present disclosure. In the example of FIG. 7, a deep neural network 702 has multiple layers, each layer generating a tensor 704-726. Skip connections 750, 752 are present in the deep neural network 702. On-chip memory 730 and off-chip memory 740 (e.g., DDR) are available for storing the tensors 704-726. In the example of FIG. 7, the on-chip memory 730 has a size of 3.5 MB.

A first tensor 704 has a size of 1 MB. Referring to FIG. 6, at block 602 it is determined if any edge is available for allocating the first tensor 704. In the example of FIG. 7, it can be seen that an edge segment 732 is available. Thus, at block 604, the edge segment 732 is allocated for the first tensor 704 and the lifespan is marked as the next layer (layer two) because the first tensor is consumed at the next layer of the deep neural network 702.

A second tensor 706 has a size of 1.5 MB. Because an edge segment 734 is available, the edge segment 734 is allocated for the second tensor 706 and the lifespan is marked as layer six due to the skip connection 750 to layer six of the deep neural network 702. A third tensor 708 has a size of 0.5 MB. Because an edge segment 732 is available, the edge segment 732 is allocated for the third tensor 708. The edge segment 732 is available because the first tensor 704 expired at layer two of the deep neural network 702. The lifespan of the third tensor 708 is marked as layer six due to the skip connection 752 to layer six of the deep neural network 702.

A fourth tensor 710 has a size of 2 MB. Because there is not enough free space available in the 3.5 MB of on-chip memory 730, the fourth tensor 710 is allocated to the off-chip memory 740. A fifth tensor 712 has a size of 1.5 MB. Because no edge segments are available, a middle segment 736 is allocated for the fifth tensor 712 and the lifespan is marked as layer six of the deep neural network 702. A sixth tensor 714 has a size of 1 MB. Because there is not enough free space available in the 3.5 MB of on-chip memory 730, the sixth tensor 714 is allocated to the off-chip memory 740.

A seventh tensor 716 and an eighth tensor 718 each have a size of 1.5 MB. Because edge segments 732, 734 are available, the edge segments 732, 734, respectively are allocated for the seventh and eighth tensors 716, 718, and the lifespans are marked as the appropriate layers of the deep neural network 702. Ninth and tenth tensors 720, 722 are allocated memory in a similar manner such that the ninth tensor 720 is allocated the edge segment 732 and the tenth tensor 722 is allocated the middle segment 736. The memory allocation for eleventh and twelfth tensors 724, 726 is not illustrated in FIG. 7 for the sake of brevity, but would operate in a similar manner.

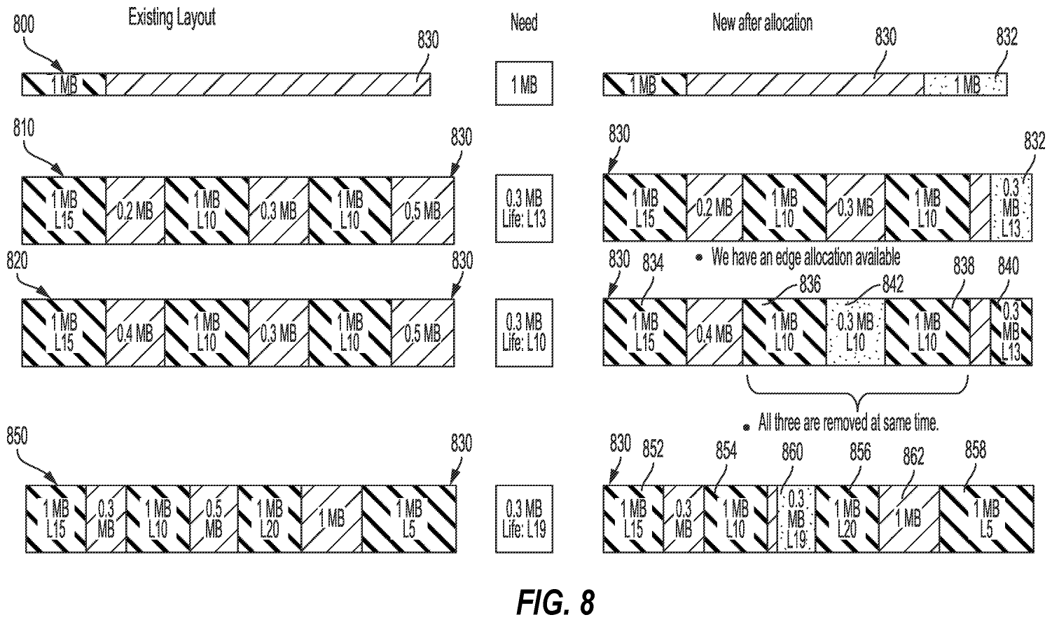

FIG. 8 is a block diagram illustrating memory allocation for a deep neural network based on lifespan data, in accordance with various aspects of the present disclosure. In the example of FIG. 8, an on-chip memory 830 is shown. Four independent examples 800, 810, 820, 850 are shown where an existing layout of the on-chip memory 830 is updated with a new memory allocation. In the first example 800, a 1 MB allocation is needed. Because an edge segment 832 is available, the 1 MB is allocated to the edge segment 832. In the second example 810, a 0.3 MB allocation is needed. Because an edge segment 832 is available, the 0.3 MB is allocated to the edge segment 832.

In the third example 820, a 0.3 MB allocation is needed. Because no edge segment is available (block 602: NO from FIG. 6), the graph aware memory allocator computes a distance between all currently allocated segments and all empty segments at block 606. In the third example 820, the lifespan of the 0.3 MB item to be stored in memory is layer 10 (L10). The currently allocated segments have lifespans of 15 (L15) in a first edge segment 834, 10 (L10) in two other segments 836, 838, and 13 (L13) in a second edge segment 840. Because the current item to be stored has a lifespan of 10 and two segments 836, 838 also have a lifespan of 10, the neighboring segment 842 is selected for storing the 0.3 MB item, between the two segments 836, 838.

In the fourth example 850, a 0.3 MB allocation is needed. Because no edge segment is available, the graph aware memory allocator computes a distance between all currently allocated segments and all empty segments. In the fourth example 850, the lifespan of the item to be stored in memory is layer 19 (L19). The currently allocated segments have lifespans of 15 (L15) in a first edge segment 852, 10 (L10) in a segment 854, 20 (L20) in another segment 856, and (L5) in a second edge segment 858. The current item to be stored has a lifespan of 19 and the segment 856 has a lifespan of 20 There are two segments 860, 862 that are adjacent to the segment 856. Thus, at block 608: NO of FIG. 6, the process moves to block 610 where the graph aware memory allocator selects the smallest segment from the closest (e.g., neighboring) segments 860, 862 and marks the validity lifespan (block 604). In the example of FIG. 8, the segment 860 is 0.3 MB and the segment 862 is 1 MB. Thus, the graph aware memory allocator selects the smallest segment 860. If there was only one segment adjacent to the segment with the closest distance (block 608: YES), the graph aware memory allocator would allocate that segment and mark validity at block 604.

As discussed above, on-chip allocation may fail due to non-availability of contiguous blocks resulting from fragmentation. Graph aware memory allocation improves on-chip memory allocation, enabling better utilization of on-chip memory when allocating tensor memory for graph neural networks. The graph aware memory allocator may be part of a neural network software development kit (SDK), such as a neural processing engine or tensor virtual machine framework. Alternatively, the graph aware memory allocator can provided as a closed component.

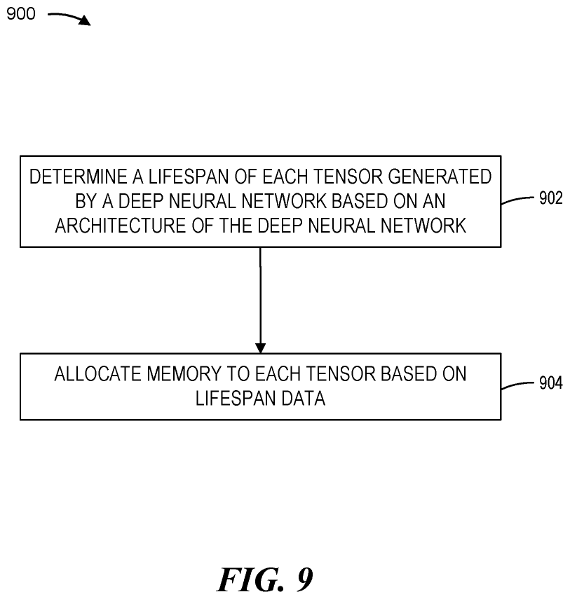

FIG. 9 is a flow diagram illustrating an example process 900 performed, for example, by a computing device, in accordance with various aspects of the present disclosure. The example process 900 is an example of graph aware memory allocation.

As shown in FIG. 9, in some aspects, the process 900 may include determining a lifespan of each tensor generated by a deep neural network based on an architecture of the deep neural network (block 902). For example, the lifespan may comprise a last neural network layer that consumes the tensor.

In some aspects, the process 900 may include allocating memory to each tensor based on lifespan data (block 904). In some aspects, the process also allocates the memory based on availability of edge segments in the memory. In still other aspects, the process allocates the memory based on minimizing a difference between a selected lifespan of a tensor to be stored in the memory and a stored lifespan of each tensor currently stored in the memory. A memory segment may be selected with a smallest size in response to more than one memory segment having a same lifespan difference from the stored lifespan. The memory may be on-chip memory.

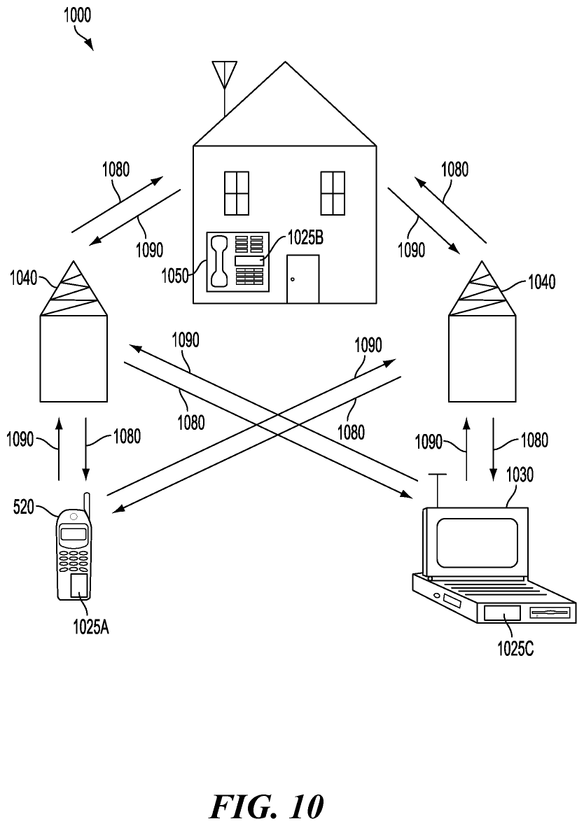

FIG. 10 is a block diagram showing an exemplary wireless communications system 1000, in which an aspect of the present disclosure may be advantageously employed. For purposes of illustration, FIG. 10 shows three remote units 1020, 1030, and 1050, and two base stations 1040. It will be recognized that wireless communications systems may have many more remote units and base stations. Remote units 1020, 1030, and 1050 include integrated circuit (IC) devices 1025A, 1025B, and 1025C that include the disclosed graph aware memory allocator. It will be recognized that other devices may also include the disclosed graph aware memory allocator, such as the base stations, switching devices, and network equipment. FIG. 10 shows forward link signals 1080 from the base stations 1040 to the remote units 1020, 1030, and 1050, and reverse link signals 1090 from the remote units 1020, 1030, and 1050 to the base stations 1040.

In FIG. 10, remote unit 1020 is shown as a mobile telephone, remote unit 1030 is shown as a portable computer, and remote unit 1050 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 10 illustrates remote units according to the aspects of the present disclosure, the disclosure is not limited to these exemplary illustrated units. Aspects of the present disclosure may be suitably employed in many devices, which include the disclosed graph aware memory allocator.

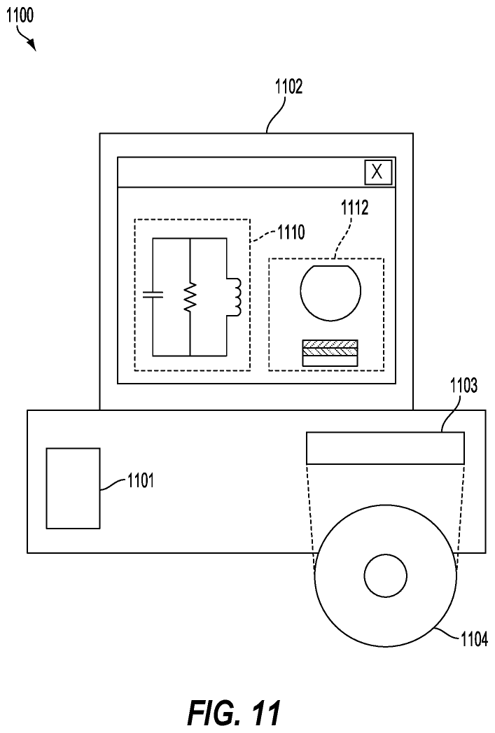

FIG. 11 is a block diagram illustrating a design workstation 1100 used for circuit, layout, and logic design of a semiconductor component, such as the graph aware memory allocator disclosed above. The design workstation 1100 includes a hard disk 1101 containing operating system software, support files, and design software such as Cadence or OrCAD. The design workstation 1100 also includes a display 1102 to facilitate design of a circuit 1110 or a semiconductor component 1112, such as the graph aware memory allocator. A storage medium 1104 is provided for tangibly storing the design of the circuit 1110 or the semiconductor component 1112 (e.g., the PLD). The design of the circuit 1110 or the semiconductor component 1112 may be stored on the storage medium 1104 in a file format such as GDSII or GERBER. The storage medium 1104 may be a CD-ROM, DVD, hard disk, flash memory, or other appropriate device. Furthermore, the design workstation 1100 includes a drive apparatus 1103 for accepting input from or writing output to the storage medium 1104.

Data recorded on the storage medium 1104 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 1104 facilitates the design of the circuit 1110 or the semiconductor component 1112 by decreasing the number of processes for designing semiconductor wafers.

### Example Aspects

Aspect 1: A processor-implemented method, comprising: determining a lifespan of each tensor generated by a deep neural network based on an architecture of the deep neural network; and allocating memory to each tensor based on lifespan data.

Aspect 2: The processor-implemented method of Aspect 1, further comprising allocating the memory based on availability of edge segments in the memory.

Aspect 3: The processor-implemented method of Aspect 1, further comprising allocating the memory based on minimizing a difference between a selected lifespan of a tensor to be stored in the memory and a stored lifespan of each tensor currently stored in the memory.

Aspect 4: The processor-implemented method of any of the preceding Aspects, further comprising selecting a memory segment with a smallest size in response to more than one memory segment having a same lifespan difference from the stored lifespan.

Aspect 5: The processor-implemented method of any of the preceding Aspects, in which the memory comprises on-chip memory.

Aspect 6: The processor-implemented method of any of the preceding Aspects, in which the lifespan comprises a last neural network layer that consumes the tensor.

Aspect 7: An apparatus, comprising: at least one memory; and at least one processor coupled to the at least one memory, the at least one processor configured: to determine a lifespan of each tensor generated by a deep neural network based on an architecture of the deep neural network; and to allocate memory to each tensor based on lifespan data.

Aspect 8: The apparatus of Aspect 7, in which the at least one processor is further configured to allocate the memory based on availability of edge segments in the memory.

Aspect 9: The apparatus of Aspect 7, in which the at least one processor is further configured to allocate the memory based on minimizing a difference between a selected lifespan of a tensor to be stored in the memory and a stored lifespan of each tensor currently stored in the memory.

Aspect 10: The apparatus of any of the Aspects 7-9, in which the at least one processor is further configured to select a memory segment with a smallest size in response to more than one memory segment having a same lifespan difference from the stored lifespan.

Aspect 11: The apparatus of claim any of the Aspects 7-10, in which the memory comprises on-chip memory.

Aspect 12: The apparatus of claim any of the Aspects 7-11, in which the lifespan comprises a last neural network layer that consumes the tensor.

Aspect 13: An apparatus, comprising: means for determining a lifespan of each tensor generated by a deep neural network based on an architecture of the deep neural network; and means for allocating memory to each tensor based on lifespan data.

Aspect 14: The apparatus of Aspect 13, further comprising means for allocating the memory based on availability of edge segments in the memory.

Aspect 15: The apparatus of Aspect 13, further comprising means for allocate the memory based on minimizing a difference between a selected lifespan of a tensor to be stored in the memory and a stored lifespan of each tensor currently stored in the memory.

Aspect 16: The apparatus of any of the Aspects 13-15, further comprising means for selecting a memory segment with a smallest size in response to more than one memory segment having a same lifespan difference from the stored lifespan.

Aspect 17: The apparatus of any of the Aspects 13-16, in which the memory comprises on-chip memory.

Aspect 18: The apparatus of any of the Aspects 13-17, in which the lifespan comprises a last neural network layer that consumes the tensor.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

What is claimed is:

1. A processor-implemented method, comprising:
determining a lifespan of each tensor generated by a deep neural network based on an architecture of the deep neural network; and
allocating memory to each tensor based on lifespan data.

2. The processor-implemented method of claim 1, further comprising allocating the memory based on availability of edge segments in the memory.

3. The processor-implemented method of claim 1, further comprising allocating the memory based on minimizing a difference between a selected lifespan of a tensor to be stored in the memory and a stored lifespan of each tensor currently stored in the memory.

4. The processor-implemented method of claim 3, further comprising selecting a memory segment with a smallest size in response to more than one memory segment having a same lifespan difference from the stored lifespan.

5. The processor-implemented method of claim 1, in which the memory comprises on-chip memory.

6. The processor-implemented method of claim 1, in which the lifespan comprises a last neural network layer that consumes the tensor.

7. An apparatus, comprising:
at least one memory; and
at least one processor coupled to the at least one memory, the at least one processor configured:
to determine a lifespan of each tensor generated by a deep neural network based on an architecture of the deep neural network; and
to allocate memory to each tensor based on lifespan data.

8. The apparatus of claim 7, in which the at least one processor is further configured to allocate the memory based on availability of edge segments in the memory.

9. The apparatus of claim 7, in which the at least one processor is further configured to allocate the memory based on minimizing a difference between a selected lifespan of a tensor to be stored in the memory and a stored lifespan of each tensor currently stored in the memory.

10. The apparatus of claim 9, in which the at least one processor is further configured to select a memory segment with a smallest size in response to more than one memory segment having a same lifespan difference from the stored lifespan.

11. The apparatus of claim 7, in which the memory comprises on-chip memory.

12. The apparatus of claim 7, in which the lifespan comprises a last neural network layer that consumes the tensor.

13. An apparatus, comprising:
means for determining a lifespan of each tensor generated by a deep neural network based on an architecture of the deep neural network; and
means for allocating memory to each tensor based on lifespan data.

14. The apparatus of claim 13, further comprising means for allocating the memory based on availability of edge segments in the memory.

15. The apparatus of claim 13, further comprising means for allocating the memory based on minimizing a difference between a selected lifespan of a tensor to be stored in the memory and a stored lifespan of each tensor currently stored in the memory.

16. The apparatus of claim 15, further comprising means for selecting a memory segment with a smallest size in response to more than one memory segment having a same lifespan difference from the stored lifespan.

17. The apparatus of claim 13, in which the memory comprises on-chip memory.

18. The apparatus of claim 13, in which the lifespan comprises a last neural network layer that consumes the tensor.
